(19) United States
(12) Patent Application Publication
(10) Pub. No.: US 2008/0212832 A1
(43) Pub. Date: Sep. 4, 2008

(54) DISCRIMINATOR GENERATING APPARATUS AND OBJECT DETECTION APPARATUS

(75) Inventors: Makoto OTSURU, Tokyo (JP); Shoji Tanaka, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/763,158

(22) Filed: Jun. 14, 2007

(30) Foreign Application Priority Data
Jan. 23, 2007 (JP) 2007-012775

(51) Int. Cl. G06K 9/00

(52) U.S. Cl. 382/103

(57) ABSTRACT

A discriminator generating apparatus includes a learning unit (21) for performing a learning process on an example image of a target object and an example image of a non-target object using a rectangle filter so as to generate a discriminator for discriminating whether an image which is a target for detection is an image of the target object, and an arbitrary angle object discriminator construction unit (22) for rotating the rectangle filter which constructs the discriminator, which is generated by the learning unit (21), by an arbitrary angle so as to generate an arbitrary angle object discriminator for carrying out detection of an object at the arbitrary angle.

### BACKGROUND OF THE INVENTION

1. Field of the Invention

The present invention relates to a discriminator generating apparatus which generates an arbitrary angle object discriminator for detecting an object included in an image which is inclined at a predetermined angle from the image, and an object detection apparatus which carries out object detection using this arbitrary angle object discriminator.

2. Description of Related Art

Conventionally, various techniques for detecting an object have been proposed, and, for example, a technique for detecting an object as disclosed in nonpatent reference 1 is known. According to this algorithm, features are extracted from a fixed rectangular area in an image using a binary rectangle filter called a rectangle filter, the features are evaluated using a judgment function, and whether or not the rectangular area is a face is then judged.

Furthermore, as a prior art technique for detecting a face image, there has been proposed a technique for detecting a face from an image and then normalizing the image in order to verify whether or not the face is a registered person's face (for example, refer to patent reference 1). In addition, there has been proposed a technique for constructing a face detector which can also support inclined images to some extent by learning face images which are inclined beforehand (for example, refer to patent reference 2).

[Patent reference 1] JP,2006-31387,A
[Patent reference 2] JP,2005-250775,A
[Nonpatent reference 1] Jones, M. J.; Viola, P., “Rapid Object Detection Using a Boosted Cascade of Simple Features”, Mitsubishi Electric Research Lab, Technical Report, TR-2004-043 May 2004.

A problem with the above-mentioned prior art technologies is, however, that in order to detect an object at an arbitrary angle, it is necessary to make the discriminator learn using an image of an object at an angle to be detected. For example, in order to detect objects at angles of 0 degrees, ±30 degrees, 60 degrees, and ±90 degrees, seven kinds of discriminators have to be constructed beforehand through learning. Therefore, a problem with such a structure is that the time required to perform the learning processing increases and the amount of memory usage increases at the time of implementation of the technology. Another problem with the prior art technique for normalizing an image is that because the normalization processing is performed at the time of detection of a face, it takes much time to carry out the detection.

### SUMMARY OF THE INVENTION

The present invention is made in order to solve the above-mentioned problems, and it is therefore an object of the present invention to a discriminator generating apparatus and an object detection apparatus which can reduce the learning time and which can easily detect an object even when the object is inclined.

In accordance with the present invention, there is provided a discriminator generating apparatus including a learning unit for performing a learning process on an example image of a target object and an example image of a non-target object using a rectangle filter so as to generate a discriminator for discriminating whether an image which is a target for detection is an image of the target object, and an arbitrary angle object discriminator construction unit for rotating the rectangle filter which constructs the generated discriminator by an arbitrary angle so as to generate an arbitrary angle object discriminator for carrying out detection of an object at the arbitrary angle.

Because the discriminator generating apparatus according to the present invention rotates the rectangle filter which constructs the discriminator by an arbitrary angle so as to generate an arbitrary angle object discriminator for carrying out detection of an object at the arbitrary angle, the learning time can be reduced and the time required to generate the discriminator which can handle an object inclined can be reduced greatly.

Further objects and advantages of the present invention will be apparent from the following description of the preferred embodiments of the invention as illustrated in the accompanying drawings.

### BRIEF DESCRIPTION OF THE DRAWINGS

FIG. 1 is an explanatory diagram showing basic forms of a rectangle filter for use in the present invention;

FIG. 2 is a block diagram showing a discriminator generating apparatus and an object detection apparatus in accordance with embodiment 1 of the present invention;

FIG. 3 is an explanatory diagram showing the operation of a search rectangle acquiring unit of the object detection apparatus in accordance with embodiment 1 of the present invention;

FIG. 4 is a flow chart showing the operation of a learning unit of the discriminator generating apparatus in accordance with embodiment 1 of the present invention;

FIG. 5 is a flow chart showing a process of calculating a threshold of the learning unit of the discriminator generating apparatus in accordance with embodiment 1 of the present invention;

FIG. 6 is an explanatory diagram showing examples of rotation of the rectangle filter of the discriminator generating apparatus in accordance with embodiment 1 of the present invention;

FIG. 7 is a flow chart showing a process of rotating the rectangle filter by the discriminator generating apparatus in accordance with embodiment 1 of the present invention;

FIG. 8 is an explanatory diagram showing an interpolation process through rotation of the rectangle filter of the discriminator generating apparatus in accordance with embodiment 1 of the present invention;

FIG. 9 is a block diagram showing a discriminator generating apparatus and an object detection apparatus in accordance with embodiment 2 of the present invention; and

FIG. 10 is an explanatory diagram showing examples of rotation of a rectangle filter in accordance with embodiment 2 of the present invention.

### DETAILED DESCRIPTION OF THE PREFERRED EMBODIMENTS

The preferred embodiments of the present invention will be now described with reference to the accompanying drawings. In the following description of the preferred embodiments, like reference numerals refer to like elements in the various views. Embodiment 1.

Prior to explanation of embodiment 1, a rectangle filter for use in the present invention will be explained.

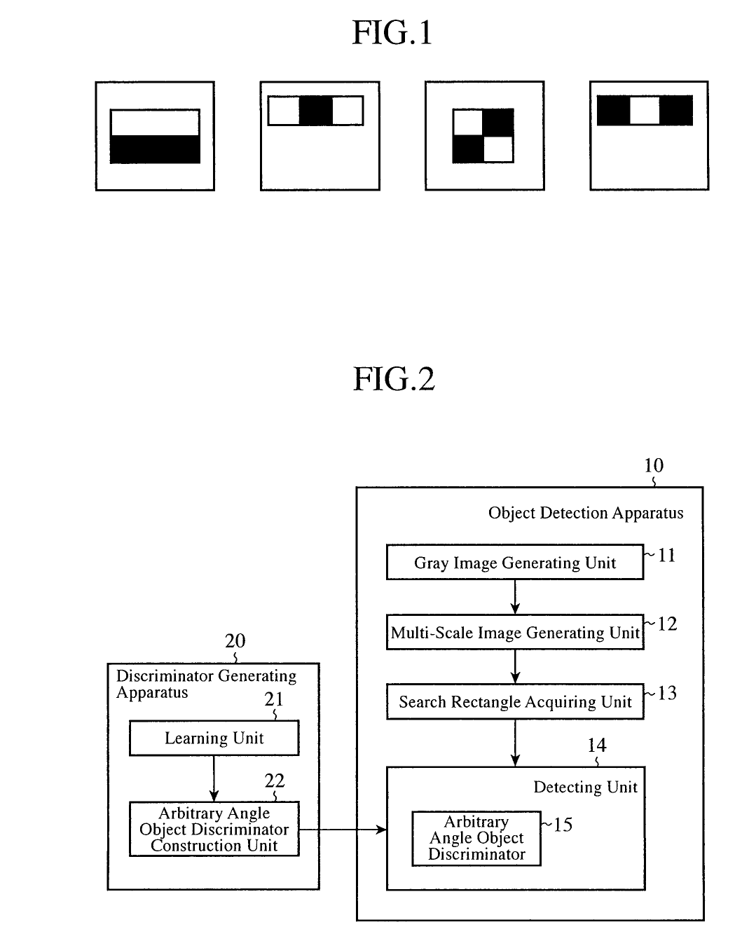

FIG. 1 is an explanatory diagram showing basic forms of a rectangle filter for use in the present invention.

A rectangle filter is a binary rectangle filter which is a combination of one or more white rectangles and one or more black rectangles, as shown in the figure, and the features of an image are evaluated using this rectangle filter. The value of a rectangle filter is obtained by subtracting the sum of one or more small black rectangular areas which lie within a search rectangle as shown in FIG. 1 from the sum of one or more small white rectangular areas which lie within the search rectangle, and can be given by the following equation (1):

f(x)=I₁−I₂ (1)

where x shows the image, I₁ is the sum of the value of the one or more white rectangular pixels shown in FIGS. 1, and I₂ is the sum of the value of the one or more black rectangular pixels shown in FIG. 1.

There exist various kinds of rectangle filters in each of which the sizes, positions, and angles of the plurality of small rectangle areas are varied in the rectangle. One assumption is created using such a rectangle filter, and a detector, such as a face detector, for detecting a target object is constructed by combining a number of assumptions. In order to construct a face detector, a learning algorithm called Adaboost is used, for example. Adaboost is the algorithm of constructing a classifier in order to discriminate between given positive examples and negatives examples, creating a plurality of different assumptions while changing the weights of the examples sequentially, and constructing a discriminator with high detection accuracy by combining the plurality of different assumptions. An assumption function hₜ can be given by the following equation (2):

$${h}_{t} ( x ) = \{ \begin{matrix}{w}_{p} : f ( x ) > th \\ {w}_{n} : f ( x ) \leq th\end{matrix} \qquad ( 2 )$$

where f is the rectangle filter, x is image data about an image in the search rectangle, th is a threshold, and wp and wn are weights which depend upon the threshold. However, the image data x is the one about the image on which a normalization process is performed so that it responds to a change in the lighting conditions. According to Adaboost, in the above-mentioned serial processing, an assumption function hₜ which minimizes the following equation (3) is selected, and a discriminator which is a combination of a plurality of assumption functions hₜ is finally constructed.

$${Z}_{t} = {\sum }_{i} {D}_{t} ( i ) exp ( - {y}_{i} {h}_{i} ( {x}_{i} ) ) \qquad ( 3 )$$

where Dₜ is a weight assigned to data given as an example, yᵢ is a label for identifying the positive/negative of the ith image data xi and {+1, −1} is used as the label, and t is the number of times that the serial processing is performed, i.e., the number of times that learning is performed. wp and wn in hₜ are defined by the following equation (4).

$${W}_{p} = log \sqrt{\frac{{W}_{++}}{{W}_{--}}} \\ {W}_{n} = log \sqrt{\frac{{W}_{--}}{{W}_{- +}}} \qquad ( 4 )$$

Wpq is the reliability of identification in hₜ which is assigned according to the threshold, and is defined as follows:

W++: the sum of weights Dₜ assigned to data larger than the threshold and whose given label is positive;

W+−: the sum of weights Dₜ assigned to data larger than the threshold and whose given label is negative;

W−+: the sum of weights Dₜ assigned to data smaller than the threshold and whose given label is positive; and

W−−: the sum of weights Dₜ assigned to data smaller than the threshold and whose given label is negative.

Thus, because Dₜ shown in the equation (3) is included in hₜ, the equation (3) can be shown by the following equation:

$${Z}_{t} = {\sum }_{i} exp ( - {y}_{i} {h}_{i} ( {x}_{i} ) ) \qquad ( 5 )$$

In the learning processing, the threshold is set up from the value f of each rectangle filter so that the function value shown by the equation (5) is minimized, and a minimum one of Zₜ values which correspond to all the rectangle filters is selected as hₜ. In each learning process t, a threshold which minimizes False Positive (an erroneous detection) and False Negative (an omission of the detection) is set up from the output value of the discriminator for each data, and the learning process is ended when the False Positive and False Negative reach their respective target accuracies, respectively. The discriminator H(x) which is thus constructed is shown by the following equation (6). In contrast, when the False Positive and False Negative do not reach their respective target accuracies, respectively, the weight Dₜ of each data is updated according to the following equation (7), and is then used in the next learning process. A weight is equally assigned to each data at the first learning.

$$H ( x ) = \{ \begin{matrix}1 \text{:} {\sum }_{i} {h}_{i} ( x ) > TH \\ 0 \text{:} {\sum }_{i} {h}_{i} ( x ) \leq TH\end{matrix} \qquad ( 6 )$$

where TH is the threshold of the discriminator, and it is determined that the image data x is image data about a face if H(x) is 1, and it is determined that the image data x is image data about a non-face if H(x) is 0.

$${D}_{t + 1} ( i ) = \frac{{Z}_{t}}{\prod {Z}_{t}} \qquad ( 7 )$$

Next, the object detection apparatus for carrying out detection of an object using such a rectangle filter will be explained. In this embodiment, a case in which the object detection apparatus is applied to detection of a face image, which is an example of detection of an object, will be explained. It cannot be overemphasized that this embodiment can also be applied to detection of an image other than a face image.

FIG. 2 is a block diagram showing the discriminator generating apparatus and object detection apparatus according to this embodiment.

As shown in FIG. 2, the object detection apparatus 10 is provided with a gray image generating unit 11, a multi-scale image generating unit 12, a search rectangle acquiring unit 13, and a detecting unit 14, and the discriminator generating apparatus 20 is provided with a learning unit 21 and an arbitrary angle object discriminator construction unit 22.

The gray image generating unit 11 is a functional unit for generating a gray image from an image inputted to the object detection apparatus 10, the multi-scale image generating unit 12 is a functional unit for generating two or more images with different scales from the gray image according to the size of a face to be detected, the search rectangle acquiring unit 13 is a functional unit for scanning the generated two or more images with different scales so as to acquire a search rectangle on which the face detection processing is to be performed in turn, and the detecting unit 14 is a functional unit for identifying whether or not an image in each of all search rectangles acquired is a face image using an arbitrary angle object discriminator 15 generated by the discriminator generating apparatus 20.

The learning unit 21 of the discriminator generating apparatus 20 is a functional unit for performing a learning process on an example image of a target object and an example image of a non-target object using the rectangle filter so as to generate a discriminator for discriminating whether an image which is a target for detection is an image of the target object, and the arbitrary angle object discriminator construction unit 22 is a functional unit for rotating the rectangle filter which constructs the discriminator generated by the learning unit 21 by an arbitrary angle so as to generate an arbitrary angle object discriminator for carrying out detection of an object at an arbitrary angle.

Next, the operation of the object detection apparatus 10 shown in FIG. 2 will be explained.

First, the gray image generating unit 11 generates a gray image from an object image on which face detection is to be performed. In order to generate a gray image, the gray image generating unit can use the following equation (8):

gray=0.299R+0.587G+0.114B (8)

where gray shows the value of each pixel of the converted gray image, R shows the value of each Red pixel of the object image, G shows the value of each Green pixel of the object image, and B shows the value of each Blue pixel of the object image.

Next, the multi-scale image generating unit 12 generates two or more images with different scales according to a detection size by scaling the generated gray image. The multi-scale image generating unit then delivers the generated two or more images with different scales to the search rectangle acquiring unit 13. In this case, as a method of scaling the generated gray image, a bi-linear method can be used. The bi-linear method is a kind of primary complement, and uses four points in the vicinity of (m/A, n/A) when multiplying the size of the inputted image f(i, j) by A. In other words, when parameters are defined as shown in the following equation (9), each scaled image is given by the following equation (10):

λₓ=m/A−└m/A┘(0≦δₓ≦1)

δ_{y}=n/A−└n/A┘(0≦δ_{y}≦1)

f₀₀=f(└m/A┘,└n/A┘)

f₁₀=f(└m/A+1┘,└n/A┘)

f₀₁=f(└m/A,└n/A+1┘)

f₁₁=f(└m/A+1┘,└n/A+1┘) (9)

$${f}^{′} ( m , n ) = {\{ ( \begin{matrix}{f}_{00} & {f}_{10} \\ {f}_{01} & {f}_{11}\end{matrix} ) ( \begin{matrix}1 - {δ}_{x} \\ {δ}_{x}\end{matrix} ) \}}^{T} ( \begin{matrix}1 - {δ}_{y} \\ {δ}_{y}\end{matrix} ) \qquad ( 10 )$$

As an alternative, another method, such as a nearest neighbor method, can be used as the method of scaling the generated gray image.

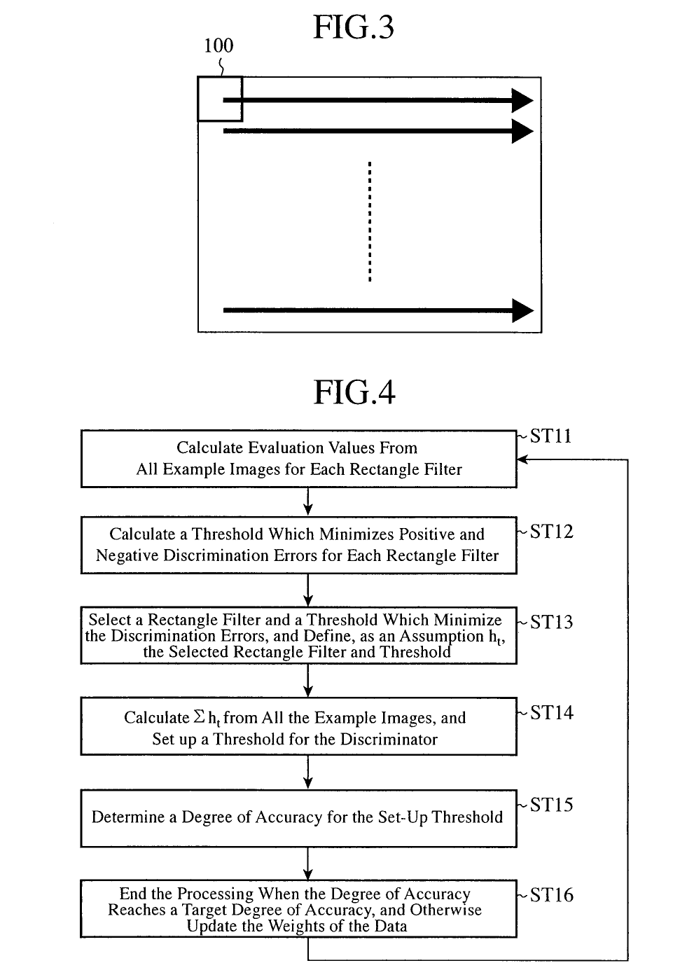

The search rectangle acquiring unit 13 then scans the whole of each of the two or more images with different scales, as shown in FIG. 3, and acquires in turn a search rectangle 100 on which the detection processing is to be performed, and delivers it to the detecting unit 14. Because images which have a constant rectangle size on which the detection processing is to be performed, but have different scales are sequentially inputted from the multi-scale image generating unit 12 to the detecting unit 14, the detecting unit 14 can detect a face having an arbitrary size.

Finally, the detecting unit 14 discriminates whether or not the given rectangle is a face which is the target for detection. That is, the detecting unit 14 judges whether or not the rectangular area is a face to be detected using the arbitrary angle object discriminator 15 constructed by the discriminator generating apparatus 20. The details of this judgment process will be mentioned later.

Next, the operation of the discriminator generating apparatus 20 will be explained.

The learning unit 21 constructs a discriminator which is a combination of assumptions from rectangle filters by performing a learning process on an example image using the rectangle filters.

FIG. 4 is a flow chart showing the operation of the learning unit 21.

First, the learning unit calculates evaluation values from all example images for each rectangle filter (in step ST11) Rectangle filters (i.e., rectangle filters in each of which the sizes, positions, and angles of the plurality of small rectangle areas of a basic rectangle filter as shown in FIG. 1 are varied in the rectangle) and example images (a plurality of face images and a plurality of non-face images) are prepared beforehand.

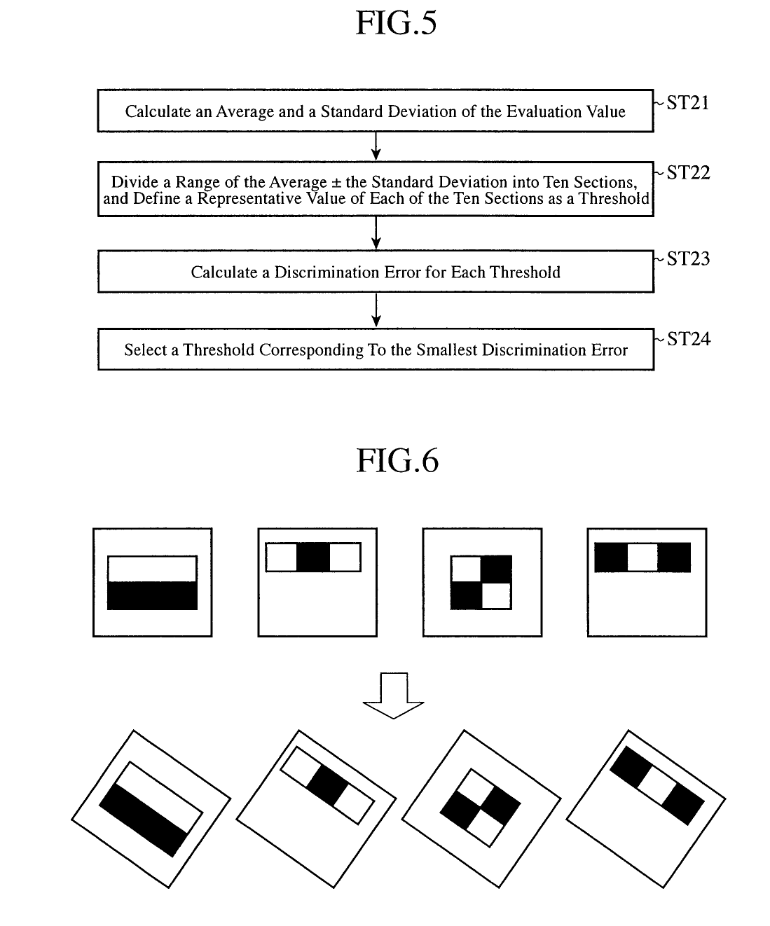

The learning unit then calculates a threshold which minimizes errors which occur at the time of judging each example image for each rectangle filter (in step ST12). The process of calculating the threshold will be explained with reference to FIG. 5. FIG. 5 is a flow chart showing the process of calculating the threshold.

First, the learning unit calculates an average and a standard deviation of the evaluation values of all the example images which it has calculated for each rectangle filter (in step ST21). The learning unit then divides a range of the average the standard deviation into ten sections, and defines a representative value of each of the ten sections as a threshold (in step ST22). The learning unit further calculates a discrimination error shown by the following equation (11) for each threshold (in step ST23), and selects a threshold corresponding to the smallest discrimination error (in step ST24).

$$ɛ = {\sum }_{i : {y}_{i} = + 1 \hat{} f ( {x}_{i} ) \leq th} {D}_{i} + {\sum }_{i : {y}_{i} = - 1 \hat{} f ( {x}_{i} ) > th} {D}_{i} \qquad ( 11 )$$

where ε is the error value, yᵢ is a label (1: positive, −1: negative) showing whether each example image is positive or negative, th is the threshold, and Dᵢ is a weight assigned to each example image. Dᵢ will be mentioned later.

Referring again to FIG. 4, the learning unit selects a rectangle filter and a threshold which minimize the discrimination errors and defines, as an assumption hₜ, the selected rectangle filter and threshold (in step ST13). The assumption hₜ is given by the following equation (12):

$${h}_{t} ( x ) = \{ \begin{matrix}{w}_{p} \text{:} f ( x ) > th \\ {w}_{n} \text{:} f ( x ) \leq th\end{matrix} \qquad ( 12 )$$

where wp and wn show weights according to the threshold and are given by the following equation (13):

$${w}_{p} = \frac{1}{2} log \sqrt{\frac{{W}_{++}}{{W}_{+ -}}} \\ {w}_{n} = \frac{1}{2} log \sqrt{\frac{{W}_{--}}{{W}_{- +}}} \qquad ( 13 )$$

where Wpq is shown by the following equation (14):

$${W}_{++} = {\sum }_{i : {y}_{i} = 1 \hat{} f ( {x}_{i} ) > th} {D}_{i} \\ {W}_{+ -} = {\sum }_{i : {y}_{i} = - 1 \hat{} f ( {x}_{i} ) > th} {D}_{i} \\ {W}_{- +} = {\sum }_{i : {y}_{i} = 1 \hat{} f ( {x}_{i} ) \leq th} {D}_{i} \\ {W}_{--} = {\sum }_{i : {y}_{i} = - 1 \hat{} f ( {x}_{i} ) \leq th} {D}_{i} \qquad ( 14 )$$

The learning unit then calculates Σhₜ(x) from all the example images, and sets up a threshold for the discriminator (in step ST14). At this time, the learning unit sets up, as a threshold, a value which minimizes False Positive and False Negative on the basis of Σhₜ(x) calculated from all the example images.

Finally, the learning unit determines a degree of accuracy for the set-up threshold (in step ST15), and constructs a discriminator and then ends the processing when the degree of accuracy reaches a target degree of accuracy (in step ST16). The discriminator H(x) constructed is shown by the following equation (15). In contrast, when the degree of accuracy does not reach the target degree of accuracy, the learning unit updates the weights using the following equation (16) (in step ST16), and repeats the processing from step ST11. At the time of the first-time learning processing, equal weights are assigned to the data, respectively.

$$H ( x ) = \{ \begin{matrix}1 \text{:} {\sum }_{i} {h}_{i} ( x ) > TH \\ 0 \text{:} {\sum }_{i} {h}_{i} ( x ) \leq TH\end{matrix} \qquad ( 15 )$$

where TH shows the threshold of the discriminator, and the search area is a face if H(x) is 1 and is a non-face if H(x) is 0.

$${D}_{t + 1} ( i ) = \frac{{Z}_{t}}{\prod {Z}_{t}} \qquad ( 16 )$$

Zₜ is a normalization factor which makes

$${\sum }_{i} {D}_{t + 1} ( i ) = 1$$

equal to 1, and is shown by the following equation (17):

$${Z}_{t} = {\sum }_{i} exp ( - {y}_{i} {h}_{i} ( {x}_{i} ) ) \qquad ( 17 )$$

Because the discriminator thus constructed by the learning unit 21 can discriminate only a face at an angle which has been processed through the learning, the arbitrary angle object discriminator construction unit 22 constructs a discriminator which can discriminate a face other than faces at the angle which has been processed through the learning.

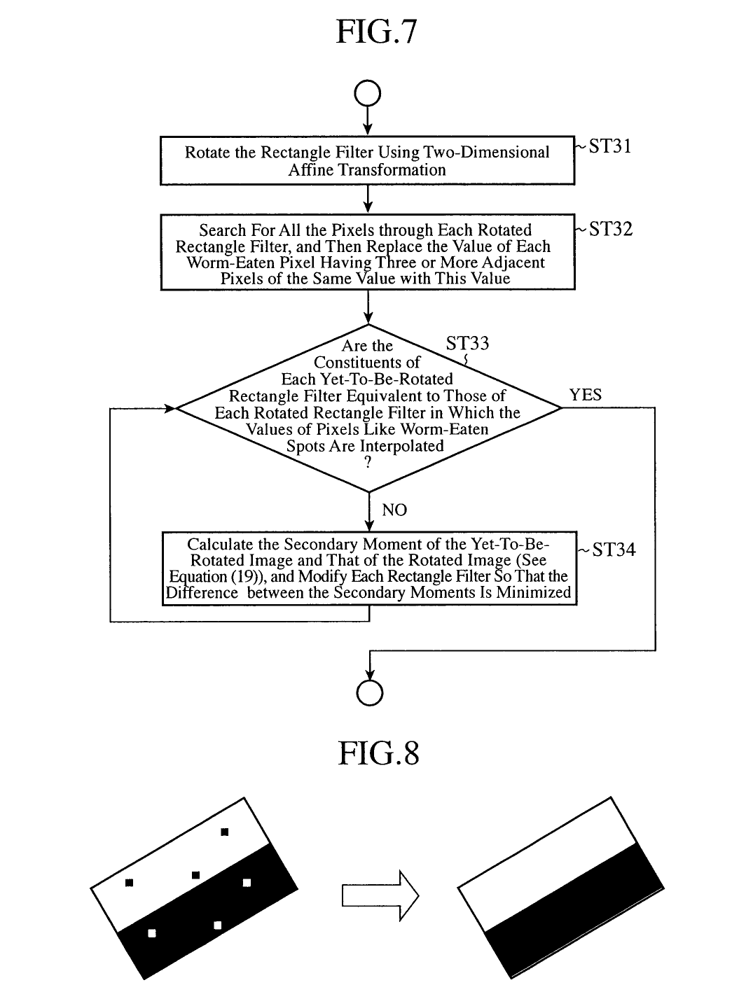

The arbitrary angle object discriminator construction unit 22 constructs a discriminator which can detect a face at an arbitrary angle by rotating the rectangle filters which construct the discriminator as shown in FIG. 6. An algorithm of rotating the rectangle filters will be explained with reference to FIG. 7.

FIG. 7 is a flow chart for explaining the rotation algorithm of rotating the rectangle filters which the arbitrary angle object discriminator construction unit 22 uses.

First, the arbitrary angle object discriminator construction unit rotates the rectangle filters using an affine transformation, i.e., the following equation (18) (in step ST31):

$$[ \begin{matrix}dx \\ dy\end{matrix} ] = [ \begin{matrix}cos θ - sin θ \\ sin θ + cos θ\end{matrix} ] [ \begin{matrix}sx \\ sy\end{matrix} ] \qquad ( 18 )$$

where dx and dy are the coordinates of each rotated rectangle filter, and sx and sy are the coordinates of each yet-to-be-rotated rectangle filter. However, only with this simple rotation differences occur between the shape and constituents of each yet-to-be-rotated rectangle filter and those of each rotated rectangle filter. This is because a floating point appears in the coordinates of each rotated rectangle filter because of the equation (18) which defines the rotation of an image. Because the coordinates of an image must be of integer type, when a floating point appears in the calculation result, it is necessary to convert this result to an integer value which is the nearest to the result. Therefore, the arbitrary angle object discriminator construction unit modifies each rotated rectangle filter when performing processes in step ST32 and subsequent steps.

In step ST32, the arbitrary angle object discriminator construction unit interpolates the values of pixels like worm-eaten spots in the rectangle as shown in FIG. 8 by searching for all the pixels through each rotated rectangle filter, and then replacing the value of each worm-eaten pixel having three or more adjacent pixels of the same value with this value. The arbitrary angle object discriminator construction unit then, in step ST33, compares the constituents of each yet-to-be-rotated rectangle filter with the constituents of each rotated rectangle filter in which the values of pixels like worm-eaten spots are interpolated, and, when the number of white rectangular pixels is equal to the number of black rectangular pixels, ends the processing. In contrast, when the number of white rectangular pixels is not equal to the number of black rectangular pixels, the arbitrary angle object discriminator construction unit performs a process of step ST34.

In step ST34, in order to make the constituents of each yet-to-be-rotated rectangle filter be equal to those of each rotated rectangle filter, the arbitrary angle object discriminator construction unit calculates the secondary moment of the yet-to-be-rotated image and that of the rotated image (see equation (19)), and modifies each rectangle filter so that the difference between the secondary moments is minimized. In other words, when the number of rectangular pixels in the rotated image is larger than the number of rectangular pixels in the yet-to-be-rotated image, the arbitrary angle object discriminator construction unit reduces the number of rectangular pixels in the rotated image by 1 so that the difference between the secondary moment of the yet-to-be-rotated image and that of the rotated image is minimized. In contrast, when the number of rectangular pixels in the rotated image is smaller than the number of rectangular pixels in the yet-to-be-rotated image, the arbitrary angle object discriminator construction unit increases the number of rectangular pixels in the rotated image by 1 so that the difference between the secondary moment of the yet-to-be-rotated image and that of the rotated image is minimized. The arbitrary angle object discriminator construction unit performs these processes on each of the white rectangular portion and black rectangular portion.

M=ΣΣ{(i−i_{g})²+(j−j_{g})²}f(i,j) (19)
(i_{g}, J_{g}): Center of gravity of Image
f(i, J): Image

After finishing the process of step ST34, the arbitrary angle object discriminator construction unit repeats the processing from step ST33 again.

The arbitrary angle object discriminator construction unit performs the above processing on all the rectangle filters which construct the discriminator, and constructs an arbitrary angle object discriminator 15 which can detect a face at an arbitrary angle.

The detecting unit 14 of the object detection apparatus 10 carries out detection of a target object using the arbitrary angle object discriminator 15 constructed through the above-mentioned processing.

The detecting unit 14 evaluates the search rectangle x received from the search rectangle acquiring unit 13 using the arbitrary angle object discriminator 15, i.e., the equation (20). The arbitrary angle object discriminator 15 is constructed by two or more assumptions shown by the equation (21). The arbitrary angle object discriminator adds wp when the evaluation value of each rectangle filter is larger than the threshold of an assumption, and adds wn otherwise. When the sum of the evaluation values of all the assumptions is larger than the threshold of the discriminator, the arbitrary angle object discriminator judges that the search rectangle is a face at an arbitrary angle.

$$\begin{matrix}H ( x ) = \{ \begin{matrix}1 \text{:} {\sum }_{i} {h}_{i}^{′} ( x ) > TH \\ 0 \text{:} {\sum }_{i} {h}_{i}^{′} ( x ) \leq TH\end{matrix} & ( 20 ) \\ {h}_{t}^{′} ( x ) = \{ \begin{matrix}{w}_{p} \text{:} {f}^{′} ( x ) > th \\ {w}_{n} \text{:} {f}^{′} ( x ) \leq th\end{matrix} & ( 21 )\end{matrix}$$

when f′ is a rotated rectangle filter and h′ is an assumption function using the rotated rectangle filter.

As mentioned above, the discriminator generating apparatus according to embodiment 1 includes the learning unit for performing a learning process on an example image of a target object and an example image of a non-target object using a rectangle filter so as to generate a discriminator for discriminating whether an image which is a target for detection is an image of the target object, and the arbitrary angle object discriminator construction unit for rotating the rectangle filter which constructs the discriminator by an arbitrary angle so as to generate an arbitrary angle object discriminator for carrying out detection of an object at the arbitrary angle. Therefore, because the discriminator generating apparatus according to this embodiment can construct the arbitrary angle object discriminator which can detect an object which is included at an arbitrary angle, and does not need to carry out new learning when generating the arbitrary angle object discriminator, the time required to generate the discriminator can be reduced greatly.

Furthermore, because the object detection apparatus according to embodiment 1 includes the detecting unit for extracting features from an image which is a target for detection using a rectangle filter and evaluating the features using a predetermined discriminant function so as to discriminate whether or not the image is an image of a specific object, and the detecting unit detects the specific object using an arbitrary angle object discriminator which is obtained by rotating the rectangle filter by a predetermined angle, the object detection apparatus according to this embodiment can easily handle an image which is included at any angle using an arbitrary angle object discriminator which is intended for the angle, and can therefore implement detection of an object at an arbitrary angle.

### Embodiment 2

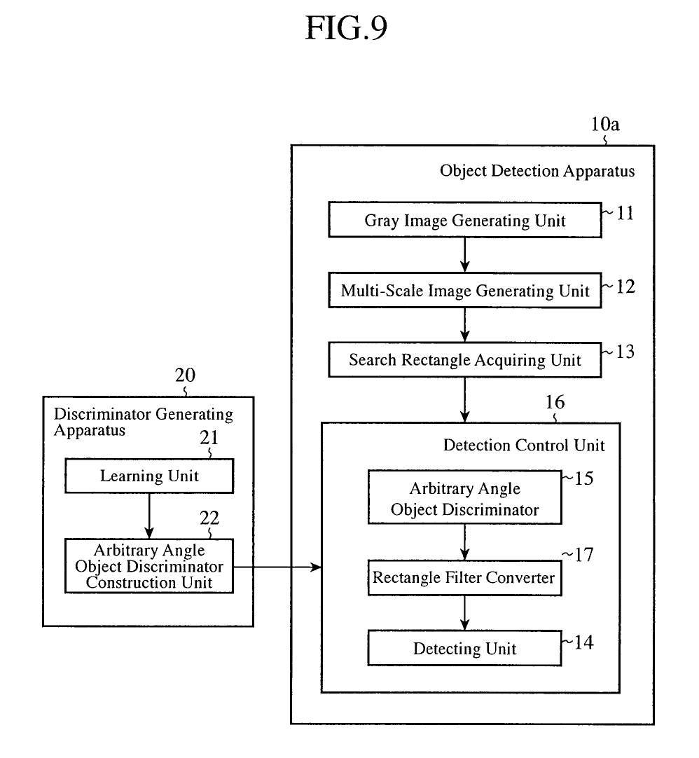

FIG. 9 is a block diagram showing a discriminator generating apparatus and an object detection apparatus according to embodiment 2.

According to embodiment 2, an object detection apparatus 10a carries out a 90-degree rotation, a 90-degree rotation, a reflection, or the like of a rectangle filter which constructs an arbitrary angle object discriminator 15, and a detecting unit 14 carries out detection processing using the arbitrary angle object discriminator 15 which carries out such a rotation process.

In FIG. 9, the object detection apparatus 10a is provided with a gray image generating unit 11, a multi-scale image generating unit 12, a search rectangle acquiring unit 13, and a detection control unit 16. Because the object detection apparatus has the same structure as that of the embodiment 1 except for the detection control unit 16, the explanation of the same components will be omitted hereafter. The discriminator generating apparatus 20 has the same structure as that according to embodiment 1.

The detection control unit 16 is provided with a rectangle filter converter 17 and a detecting unit 14, and the detecting unit 14 is the same as that of embodiment 1. The rectangle filter converter 17 is a functional unit which performs a 90-degree rotation, a 180-degree rotation, a 270-degree rotation, or a reflection which does not cause any error in the image on the rectangle filters which construct the arbitrary angle object discriminator 15, and which generates a discriminator which can detect an object at an angle other than the angle of the arbitrary angle object discriminator 15. The reason why such a 90-degree rotation, a 180-degree rotation, a 270-degree rotation, or a reflection does not cause any error in the image is as follows. In other words, according to the equation (18) which defines a rotation of an image, it is because it is guaranteed that all the coordinates of an image which is rotated in 90-degree steps or which is reflected about the x axis have integer values. For example, in a 90-degree rotation, the values of sin 90 and cos 90 are 1 and 0, respectively, and, as results of the determinant of the equation 18, integer values are certainly acquired. In the case of a reflection about a horizontal axis, i.e., an x axis, because the y coordinates of the transformed image are obtained by inversing the y coordinates of the original image, and the x coordinates of the transformed image are the same as those of the original image, all the coordinates of the transformed image have integer values.

Next, the operation of the object detection apparatus 10a according to embodiment 2 will be explained.

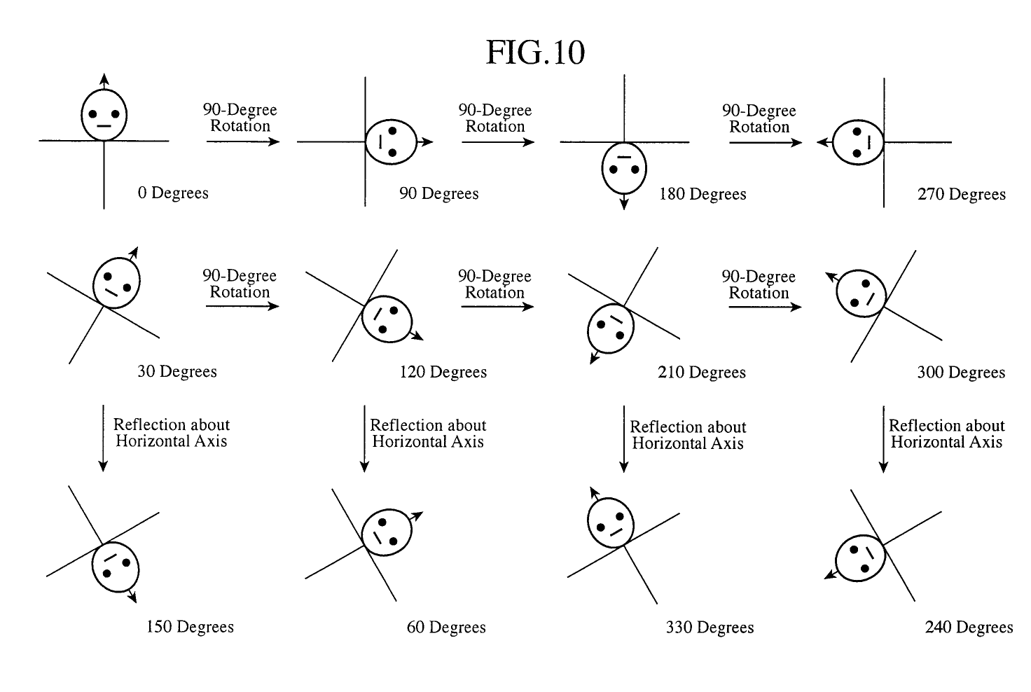

FIG. 10 is an explanatory diagram showing the operation of the object detection apparatus in a case in which the object detection apparatus detects an object at an angle other than angles which can be detected, as the arbitrary angle object discriminator 15.

Hereafter, a method of detecting a face at an angle of 0 degrees, 30 degrees, 60 degrees, 90 degrees, 120 degrees, 150 degrees, 180 degrees, 210 degrees, 240 degrees, 270 degrees, 300 degrees, or 330 degrees using only a discriminator which can detect a face at an angle of 0 degrees and a face at an angle of 30 degrees will be explained as an example. If the constructed arbitrary angle object discriminator 15 can detect only a face at an angle of 0 degrees and a face at an angle of 30 degrees among faces shown in the figure, the constructed arbitrary angle object discriminator can also detect a face at an angle of 90 degrees, a face at an angle of 180 degrees, and a face at an angle of 270 degrees by sequentially performing a 90-degree rotation, a 180-degree rotation, and a 270-degree rotation on the rectangle filter of the discriminator which can detect a face at an angle of 90 degrees first. The constructed arbitrary angle object discriminator can further detect a face at an angle of 120 degrees, a face at an angle of 210 degrees, and a face at an angle of 300 degrees by sequentially performing a 90-degree rotation, a 180-degree rotation, and a 270-degree rotation on the rectangle filter of the discriminator which can detect a face at an angle of 30 degrees. The constructed arbitrary angle object discriminator can further detect a face at an angle of 150 degrees, a face at an angle of 60 degrees, a face at an angle of 330 degrees, and a face at an angle of 240 degrees by performing a reflection on the rectangle filter of the discriminator which can detect a face at an angle of 30 degrees, the rectangle filter of the discriminator which can detect a face at an angle of 120 degrees, the rectangle filter of the discriminator which can detect a face at an angle of 210 degrees, and the rectangle filter of the discriminator which can detect a face at an angle of 300 degrees.

In this embodiment, the discriminators which can detect a face at an angle of 0 degrees and a face at an angle of 30 degrees are explained as an example. However, in accordance with embodiment 2, it cannot be overemphasized that the object detection apparatus can detect a face at an angle other than angles which can be originally detected even using discriminators for other angles.

In this embodiment 2, the object detection apparatus 10a rotates the rectangle filters which construct the arbitrary angle object discriminator 15, as previously mentioned. As an alternative, the discriminator generating apparatus 20 can be provided with the rectangle filter converter 17. In this case, the object detection apparatus 10a stores the arbitrary angle object discriminator 15 which is rotated by the discriminator generating apparatus 20, and then carries out the detection processing. Although a memory area for storing each arbitrary angle object discriminator 15 which is rotated is required, the object detection apparatus can carry out detection of an object at a high speed because it does not need to rotate the arbitrary angle object discriminator at the time of the detection processing.

As mentioned above, the object detection apparatus according to embodiment 2 includes the rectangle filter converter for rotating the rectangle filter which constructs the arbitrary angle object discriminator by a predetermined angle, and the detecting unit detects an object which is the target for detection and which is inclined at a predetermined angle using the arbitrary angle object discriminator converted by the rectangle filter converter. Therefore, this embodiment offers an advantage of being able to detect in real time an object at an angle other than angles which a certain discriminator can detect, and another advantage of being able to reduce the amounts of memory at the time of implementing the object detection apparatus because a minimal number of discriminators to be used are prepared.

Furthermore, because the rectangle filter converter of the object detection apparatus according to embodiment 2 performs a 90, 180, or 270-degree rotation or a reflection on the rectangle filter, the rectangle filter converter can easily transform the discriminator which can detect an object at a certain angle to a discriminator which detects an object at an angle other than the former angle.

In addition, because the discriminator generating apparatus according to embodiment 2 includes the rectangle filter converter for rotating the rectangle filter which constructs the arbitrary angle object discriminator by a predetermined angle, the discriminator generating apparatus can process an image of an object inclined at an arbitrary angle at a high speed when performing object detection on the image.

Furthermore, because the rectangle filter converter of the discriminator generating apparatus according to embodiment 2 performs a 90, 180, or 270-degree rotation or a reflection on the rectangle filter, the rectangle filter converter can easily transform the discriminator which can detect an object at a certain angle to a discriminator which detects an object at an angle other than the former angle.

Many widely different embodiments of the present invention may be constructed without departing from the spirit and scope of the present invention. It should be understood that the present invention is not limited to the specific embodiments described in the specification, except as defined in the appended claims.

What is claimed is:

1. A discriminator generating apparatus comprising:
a learning unit for performing a learning process on an example image of a target object and an example image of a non-target object using a rectangle filter so as to generate a discriminator for discriminating whether an image which is a target for detection is an image of the target object; and
an arbitrary angle object discriminator construction unit for rotating said rectangle filter which constructs said discriminator by an arbitrary angle so as to generate an arbitrary angle object discriminator for carrying out detection of an object at said arbitrary angle.

2. An object detection apparatus comprising:
a detecting unit for extracting features from an image which is a target for detection using a rectangle filter and evaluating said features using a predetermined discriminant function so as to discriminate whether or not said image is an image of a specific object, wherein said detecting unit detects said specific object using an arbitrary angle object discriminator which is obtained by rotating said rectangle filter by a predetermined angle.

3. The object detection apparatus according to claim 2, wherein said apparatus includes a rectangle filter converter for rotating the rectangle filter which constructs the arbitrary angle object discriminator by a predetermined angle, and the detecting unit detects an object which is a target for detection and which is inclined at a predetermined angle using the arbitrary angle object discriminator converted by said rectangle filter converter.

4. The object detection apparatus according to claim 3, wherein the rectangle filter converter performs a 90-degree, 180-degree, or 270-degree rotation or a reflection on the rectangle filter.

5. The discriminator generating apparatus according to claim 1, wherein said apparatus includes a rectangle filter converter for rotating the rectangle filter which constructs the arbitrary angle object discriminator by a predetermined angle.

6. The discriminator generating apparatus according to claim 1, wherein the rectangle filter converter performs a 90-degree, 180-degree, or 270-degree rotation or a reflection on the rectangle filter.
